(19) United States
(12) Patent Application Publication
(10) Pub. No.: US 2018/0090836 A1
(43) Pub. Date: Mar. 29, 2018

(54) Interface Module for Antenna of Communication Device

(71) Applicant: MEDIATEK INC., Hsin-Chu (TW)

(72) Inventors: Wun-Jian Lin, Kaohsiung City (TW); Chung-Yu Hung, Taipei City (TW); Chen-Fang Tai, New Taipei City (TW); Shih-Huang Yeh, Hsinchu City (TW)

(21) Appl. No.: 15/620,817

(22) Filed: Jun. 12, 2017

Related U.S. Application Data
(60) Provisional application No. 62/398,561, filed on Sep. 23, 2016.

(51) Int. Cl. H01Q 3/16; H01Q 1/24

(52) U.S. Cl. CPC H01Q 3/16; H01Q 1/243; H01Q 1/245

(57) ABSTRACT

An interface module for a communication device includes a first switch, for forming a first connection between a first feeding point of an antenna of the communication device and one of a first matching component and a first grounding component; a second switch, for forming a second connection between a second feeding point of the antenna and one of a second matching component and a second grounding component; and a third switch, for forming a third connection between a transceiver and one of the first matching component and the first grounding component.

### CROSS REFERENCE TO RELATED APPLICATIONS

This application claims the benefit of U.S. Provisional Application No. 62/398,561 filed on 2016 Sep. 23, the contents of which are incorporated herein in their entirety.

### BACKGROUND

The present invention relates to an interface module for a wireless communication device, and more particularly, to a low cost interface module for connecting an antenna and a transceiver of a wireless communication device.

Antennas can be used to transmit or receive radio frequency (RF) signals over the air when wireless communication devices are operated in a transmit (TX) mode or a receive (RX) mode. When an antenna is used in a wireless communication device (e.g. a mobile phone), the antenna may lose efficiency under certain scenarios. For example, the efficiency of the antenna in the mobile phone may be degraded by ways that a user holds the mobile phone. When the user holds the mobile phone by right hand, left hand or both hands, the hands may block the RF signals and the performance of the antenna is therefore degraded. In another scenario, the user may put the mobile phone close to either right ear or left ear when talking on the mobile phone. In addition to the hand holding the mobile phone, the user's head may further degrade the performance of the antenna.

In order to improve the performance of the antenna under different scenarios, the antenna is designed to be able to generate different radiation patterns by changing locations of a feeding point and a grounding point of the antenna. For example, the antenna is capable of changing the locations of the feeding point and the grounding point in the prior art requires tunable components, such as tunable capacitors, resulting in increase of the manufacture cost of the antenna.

Furthermore, the radiation patterns generated by the antenna with a fixed feeding point may be toward different directions when the antenna operates in different resonant frequencies. Under such a condition, the antenna in the prior art may be not suitable for carrier aggregation (CA), which is an important feature of Long Term Evolution (LTE) Advanced specifications. Thus, how to decrease the manufacture cost of the antenna while making the antenna suitable for the CA becomes a topic to be discussed.

### SUMMARY

In order to solve the above issues, the present disclosure provides a low cost interface module for connecting an antenna and a transceiver of a wireless communication device.

In an aspect, the present disclosure discloses an interface module for a communication device. The interface module comprises a first switch, for forming a first connection between a first feeding point of an antenna of the communication device and one of a first matching component and a first grounding component; a second switch, for forming a second connection between a second feeding point of the antenna and one of a second matching component and a second grounding component; and a third switch, for forming a third connection between a transceiver and one of the first matching component and the first grounding component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an interface module according to an example of the present invention.

FIG. 2 is another schematic diagram of the interface module shown in FIG. 1.

FIG. 3 is a schematic diagram of an example of the interface module according to an example of the present invention.

FIG. 4 is another schematic diagram of the interface module shown in FIG. 3.

FIG. 5 is a schematic diagram of an interface module according to an example of the present invention.

### DETAILED DESCRIPTION

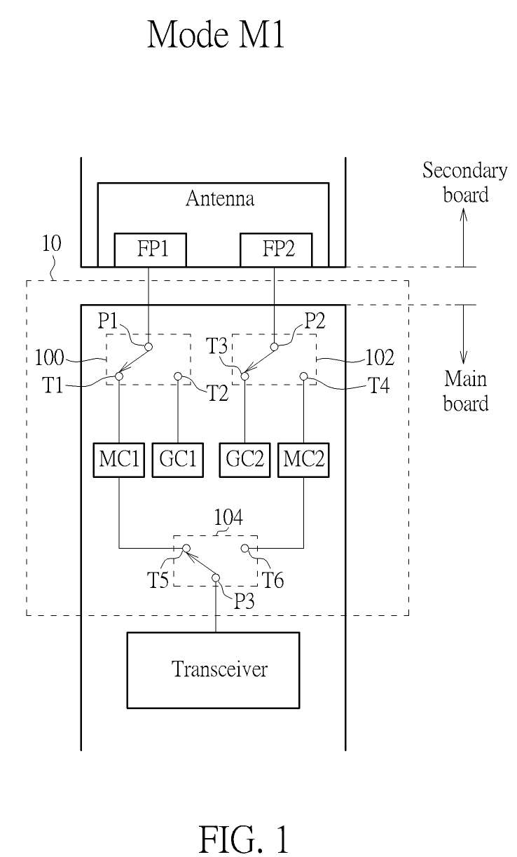

Please refer to FIG. 1, which is a schematic diagram of an interface module 10 according to an example of the present invention. The interface module 10 is utilized in a wireless communication device, such as a smart phone, a tablet, and a laptop, for connecting an antenna and a transceiver of the wireless communication device. In this example, the transceiver is configured on a main board of the wireless communication and the antenna is configured on a secondary board of the wireless communication device. The main board and the secondary board may be different parts of a metal housing of the wireless communication device. For example, the wireless communication device may comprise a metal rear cover and the main board and the secondary board are different parts of the metal rear cover, which are separated by trenches. Furthermore, the trenches may be slots of the antenna.

As shown in FIG. 1, the interface module 10 comprises switches 100, 102, and 104, matching components MC1 and MC2 and grounding components GC1 and GC2 which are all configured on the mainboard of the wireless communication device. The switch 100 comprises a pole end P1 coupled to a feeding point FP1 of the antenna, a throw end T1 coupled to the matching component MC1 and a throw end T2 coupled to the grounding component GC1 and is utilized to form a connection between the feeding point FP1 and one of the matching component MC1 and the grounding component GC1. The switch 102 comprises a pole end P2 coupled to a feeding point FP2 of the antenna, a throw end T3 coupled to the matching component GC2, and a throw end T4 coupled to the matching component MC2 and is utilized to form a connection between the feeding point FP2 and one of the grounding component GC2 and the matching component MC2. Note that, the matching components MC1 and MC2 may be capacitors and each of the grounding components GC1 and GC2 may comprise an inductance element, a capacitance element or a path connecting to the ground of the main board. The switch 104 comprises a pole end P3 coupled to the transceiver of the communication device, a throw end T5 coupled to the matching component MC1, and a throw end T6 coupled to the matching component MC2. By adopting the structure shown in FIG. 1, the number of circuit elements used to connect the antenna and the transceiver and to form signal feeding paths of transmitting signals can be minimized. Further, the interface module 10 is realized without using tunable components, such as tunable capacitors. The manufacture cost of the communication device is reduced, therefore.

In details, the interface module 10 operates in either a mode M1 or a mode M2, to generate different radiation patterns. In the example shown in FIG. 1, the interface module 10 operates in the mode M1. The switch 100 forms the connection between the feeding point FP1 and the matching component MC1, the switch 102 forms the connection between the feeding point FP2 and the grounding component GC2, and the switch 104 forms the connection between the transceiver and the matching component MC1. Under such a condition, a signal feeding path passing through the matching component MC1, the feeding point FP1, the antenna, the feeding point FP2 and the grounding component GC2 is formed, to build a radiation pattern RP1 toward a designed direction DD1.

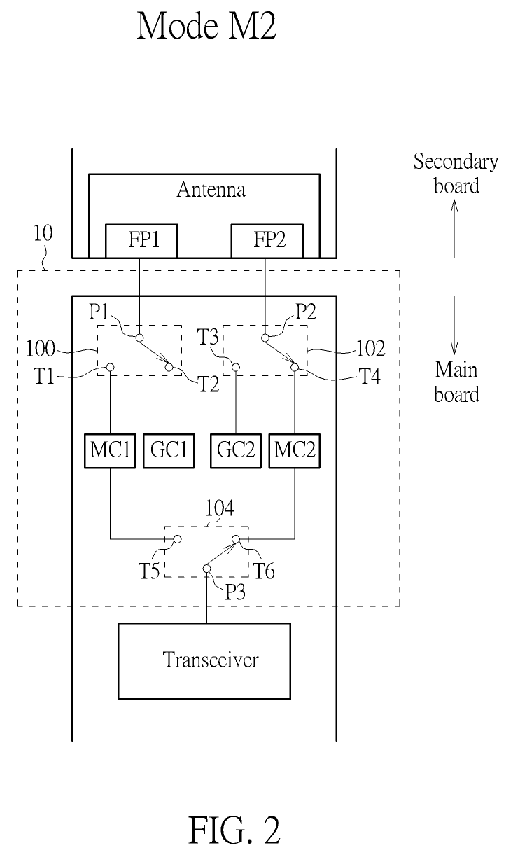

Please refer to FIG. 2, which is a schematic diagram of the interface module 10 operating in the mode M2. As shown in FIG. 2, the switch 100 forms the connection between the feeding point FP1 and the grounding component GC1, the switch 102 forms the connection between the feeding point FP2 and the matching component MC2, and the switch 104 forms the connection between the transceiver and the matching component MC2. Under such a condition, a signal feeding path passing through the matching component MC2, the feeding point FP2, the antenna, the feeding point FP1 and the grounding component GC1 is formed, to build a radiation pattern RP2 toward a designed direction DD2. Note that, the direction DD1 is different from the direction DD2. For example, the directions DD1 and DD2 may be opposite directions (e.g. left and right, or up and down).

In addition, the grounding components GC1 and GC2 may be changed according to different applications and designed concepts. For example, the grounding components GC1 and GC2 may be one of the conducing paths to the ground of the transceiver (i.e. the ground of the main board) , an inductance element, or a capacitance element, and are not limited herein. By changing the grounding components GC1 and GC2, the operating frequency of the interface module 10 can be altered to satisfy specifications of various communication protocols.

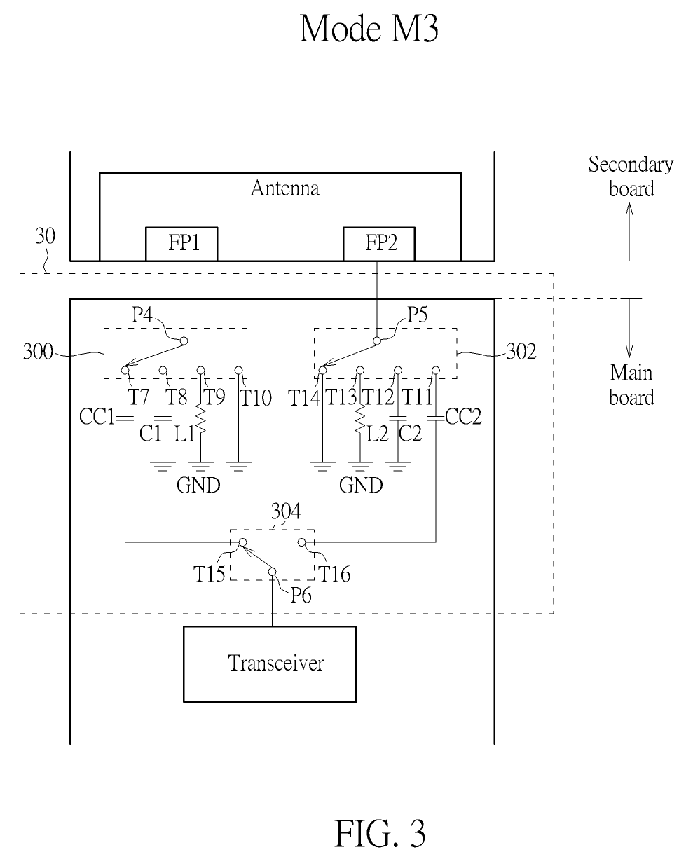

Please refer to FIG. 3, which is a schematic diagram of an interface module 30 according to an example of the present invention. Note that, the interface module 30 is similar to the interface module 10 shown in FIG. 1, and thus, the components with similar functions use the same symbols. As shown in FIG. 3, the interface module 30 comprises switches 300, 302, and 304, capacitors CC1, CC2, C1, and C2, and inductors L1 and L2. In FIG. 3, the switches 300 comprises a pole end P4 coupled to the feeding point FP1 of the antenna, a throw end T7 coupled to the capacitor CC1, a throw end T8 coupled to the capacitor C1, a throw end T9 coupled to the inductor L1 and a throw end T10 coupled to the ground GND. The switch 300 is utilized to form a connection between the pole end P4 (i.e. the feeding point FP1) and one of the throw ends T7-T10. Similarly, the switch 302 comprises a pole end P5 coupled to the feeding point FP2 of the antenna, a throw end T11 coupled to the capacitor CC2, a throw end T12 coupled to the capacitor C2, a throw end T13 coupled to the inductor L2 and a throw end T14 coupled to the ground GND. The switch 302 is utilized to form a connection between the pole end P5 (i.e. the feeding point FP2) and one of the throw ends T11-T14. The switch 304 comprises a pole end P6 coupled to the transceiver, a throw end T15 coupled to the capacitor CC1 and a throw end T16 coupled to the capacitor CC2, and is utilized to form a connection between the pole end P6 (i.e. the transceiver) and one of the throw ends T15 and T16. In an example, the switches 300 and 302 are single pole 4 throws (SP4T) switches and the switch 304 is a single pole double throws (SP2T) switch. By switching the switches 300, 302 and 304, the interface module 30 is able to provide two different radiation patterns via minimum number of circuit elements.

Details of operations of the interface module 30 are briefly narrated in the following. When operating in a mode M3 similar to the mode M1 of the interface module 10, the switch 300 forms the connection between the feeding point FP1 and the throw end T7, the switch 302 forms the connection between the feeding point FP2 and one of the throw ends T12-T14, and the switch 304 forms the connection between the transceiver and the throw end T15. In other words, one of the capacitor C2, the inductor L2 and the ground GND can be analogous to the grounding component GC2 shown in FIG. 1.

In the example shown in FIG. 3, the switch 304 forms the connection between the feeding point FP2 and the throw end T14. Under such a condition, a conducting path passing through the capacitor CC1, the feeding point FP1, the antenna, the feeding point FP2 and one of the capacitor C2, the inductor L2 and the ground GND is formed, to build the radiation pattern RP3 toward a designed direction DD3.

Note that, the resonant frequency of the antenna may be altered by switching the switch 302 to be coupled to the throw ends T12, T13 or T14 when the interface module 30 operates in the mode M3. In an example, the resonant frequency of the antenna is designed at 900 MHz when operating in the mode M3 and the switch 302 forms the connection between the pole end P5 and the throw end T14. By switching the switch 302 to form the connection between pole end P5 and the throw end T12 when the interface module 30 operates in the mode M3, the capacitance of the signal feeding path increases and the resonant frequency of the antenna accordingly increases (e.g. increases to 950 MHz). On the other hand, the inductance of the signal feeding path increases by altering the switch 302 to form the connection between the pole end P5 and the throw end T13. The resonant frequency of the interface module 30 therefore decreases (e.g. decreases to 850 MHz). In this example, the resonant frequency of the interface module 30 is able to change within 850 MHz-950 MHz by altering the connection formed by the switch 302.

In an example, the interface module 30 operates in a mode M4 similar to the mode M2 of the interface module 10. In this example, the switch 300 forms the connection between the feeding point FP1 and one of the throw ends T8-T10, the switch 302 forms the connection between the feeding point FP2 and the throw end T11, and the switch 304 forms the connection between the transceiver and the throw end T16. Under such a condition, a signal feeding path passing through the capacitor CC2, the feeding point FP2, the antenna, the feeding point FP1 and one of the capacitor C1, the inductor L1 and the ground GND is formed, to create a radiation pattern RP4 toward a designed direction DD4. That is, one of the capacitor C1, the inductor L1 and the ground GND can be analogous to the grounding component GC1 shown in FIG. 1. In an example, the directions DD3 and DD4 may be opposite directions (e.g. left and right, or up and down).

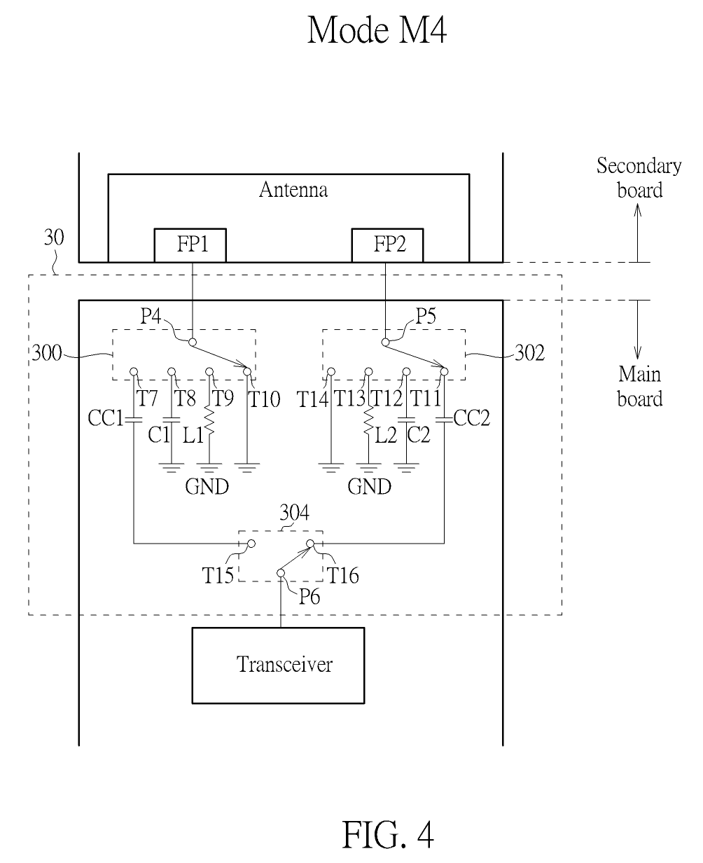

Please refer to FIG. 4, which is a schematic diagram of the interface module 30 operating in the mode M4. In FIG. 4, the switch 300 forms the connection between the feeding point FP1 and the throw end T10. Under such a condition, a conducting path passing through the capacitor CC1, the feeding point FP1, the antenna, the feeding point FP2 and one of the capacitor C2, the inductor L2 and the ground GND is formed, to build the radiation pattern RP4.

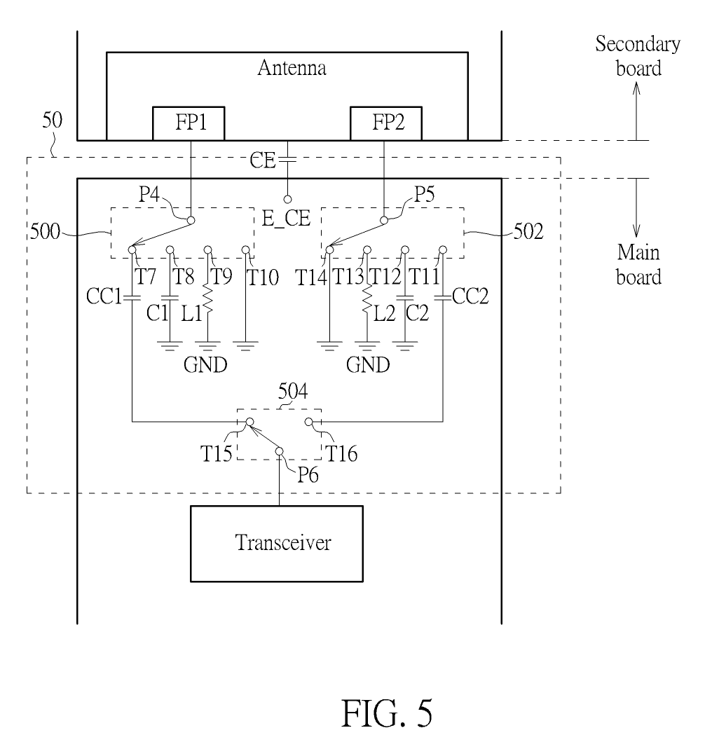

Please refer to FIG. 5, which is a schematic diagram of an interface module 50 according to an example of the present invention. The interface module 50 is similar to the interface module 30 shown in FIG. 3, and thus, the components and signals with the similar functions use the same symbols. Different from the interface module 30, the interface module 50 adds a capacitance element CE whose one end is coupled to the antenna and another end is coupled to an end E_CE of the main board. By adding the capacitance element CE, additional conducting paths (e.g. a path from the feeding point FP1 to the end E_CE and another path from the feeding point FP2 to the end E_CE) are generated and the antenna has new resonant modes. The resonant frequency range of the antenna shown in FIG. 5 is extended to a higher resonant frequency, therefore.

In addition, the directions of single radiation pattern of the antenna when operating in different frequencies can be the same by adding the capacitance element CE. That is, the interface module 50 makes the antenna suitable for carrier aggregation (CA) application.

In an example, the end E_CE is coupled to the ground GND of the main board. In another example, the antenna is a slot antenna and the capacitance element CE is across a slot of the slot antenna. That is, the end E_CE is coupled to one end of the slot of the antenna. In an example, the secondary board is an upper part of a metal rear cover of the communication device, the mainboard is a lower part of the metal rear cover, and a slot of the antenna is configured between the upper part and the lower part of the metal rear cover. In this example, one end of the capacitance element CE is coupled to the upper part of the metal rear cover and another end of the capacitance element CE is coupled to the lower part of the metal rear cover.

Note that, the position at which the capacitance element CE and the antenna are coupled is not limited to that shown in FIG. 5 (i.e. the position between the feeding points FP1 and FP2). For example, the capacitance element CE may change to be coupled to the antenna at an end located at right of the feeding point FP2 or another end located at left of the feeding point FP1.

To sum up, the interface module of the above example is realized in the compact structure without using high cost components. Via adding the capacitance element between the antenna and the interface module, the frequency range of antenna is extended and the directions of the radiation pattern keep the same when the antenna operates in different frequencies.

Those skilled in the art will readily observe that numerous modifications and alterations of the device and method may be made while retaining the teachings of the invention. Accordingly, the above disclosure should be construed as limited only by the metes and bounds of the appended claims.

1. An interface module for a communication device, comprising:
a first switch, for forming a first connection between a first feeding point of an antenna of the communication device and one of a first matching component and a first grounding component;
a second switch, for forming a second connection between a second feeding point of the antenna and one of a second matching component and a second grounding component; and
a third switch, for forming a third connection between a transceiver and one of the first matching component and the first grounding component.

2. The interface module of claim 1, wherein at least one of the first grounding component and the second grounding component comprises an inductance element.

3. The interface module of claim 1, wherein at least one of the first grounding component and the second grounding component comprises a capacitance element.

4. The interface module of claim 1, wherein the first matching component comprises a first coupling capacitor coupled between a first throw end of the first switch and a second thrown end of the third switch and the second matching component comprises a second coupling capacitor coupled between a third throw end of the second switch and a fourth thrown end of the third switch.

5. The interface module of claim 4, wherein the first grounding component comprises a fifth conducting path coupled between a sixth throw end of the first switch and the ground and the second grounding component comprises a first conducting path coupled between a fifth throw end of the second switch and the ground.

6. The interface module of claim 5, wherein the first grounding component comprises a first capacitor coupled between a seventh throw end of the first switch and a ground of the mainboard and the second grounding component comprises a second capacitor coupled between a eighth throw end of the second switch and the ground.

7. The interface module of claim 5, wherein the the first grounding component comprises a first inductor coupled between a ninth throw end of the first switch and the ground and the second grounding component comprises a second inductor coupled between a tenth throw end of the second switch and the ground.

8. The interface module of claim 1, wherein the first switch forms the first connection between the first feeding point and the first matching component, the second switch forms the second connection between the second feeding point and the second grounding component, and the third switch forming the third connection between the transceiver and the first matching component when the interface module operates in a first mode.

9. The interface module of claim 8, wherein the second grounding component is one of an inductor, a capacitor and a conducting path to a ground of the mainboard.

10. The interface module of claim 1, wherein the first switch forms the first connection between the first feeding point and the first grounding component, the second switch forms the second connection between the second feeding point and the second matching component, and the third switch forming the third connection between the transceiver and the second matching component when the interface module operates in a second mode.

11. The interface module of claim 10, wherein the first grounding component is one of an inductor, a capacitor and a conducting path to a ground of the mainboard.

12. The interface module of claim 1, further comprising:
a capacitance element, coupled between the antenna and a transceiver ground of the transceiver.

13. The interface module of claim 1, further comprising:
a capacitance element, coupled across a slot of the antenna.

14. The interface module of claim 1, further comprising:
a capacitance element, coupled between a first part of a metal housing of the communication device and a second part of the metal housing of the communication device.
